(19) United States
(12) Patent Application Publication
(10) Pub. No.: US 2022/0319126 A1
(43) Pub. Date: Oct. 6, 2022

(54) SYSTEM AND METHOD FOR PROVIDING AN AUGMENTED REALITY ENVIRONMENT FOR A DIGITAL PLATFORM

(71) Applicant: FLIPKART INTERNET PRIVATE LIMITED, Bengaluru (IN)

(72) Inventors: Sriram Venkateswaran Iyer, Chennai (IN); Varahur Kannan Sai Krishna, Bangalore (IN); Ajay Ponna Venkatesha, Bangalore (IN)

(73) Assignee: FLIPKART INTERNET PRIVATE LIMITED, Bengaluru (IN)

(21) Appl. No.: 17/707,714

(22) Filed: Mar. 29, 2022

(30) Foreign Application Priority Data
Mar. 31, 2021 (IN) 202141015101

(51) Int. Cl. G06T 19/00; G06F 3/04883; G06F 3/01

(52) U.S. Cl. CPC G06T 19/006; G06F 3/04883; G06F 3/013

(57) ABSTRACT

A system and method for providing an augmented reality environment for a digital platform. The method encompasses receiving, at a transceiver unit [102] from an electronic device, a user input via the digital platform, wherein the user input comprises at least one camera invoking gesture. The method thereafter comprises enabling, by a processing unit [104], a camera functionality of a camera unit of the electronic device, based on the camera invoking gesture. Further the method encompasses receiving, by the processing unit [104] from one or more sensors, a surrounding environment data based on the enabled camera functionality. Further the method comprises generating, by the processing unit [104], the augmented reality environment associated with the digital platform, based on the surrounding environment data.

### TECHNICAL FIELD

The technical field generally relates to augmented reality techniques and more particularly to systems and methods for providing an augmented reality environment for a digital platform with one or more gestures.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With the advancement in the various digital technologies over the past few years, the virtual reality (VR) and augmented reality (AR) techniques are also enhanced to a great extent. Virtual Reality (VR) is a field of interaction with 3D virtual space created by a computer system, and virtual space is constructed based on real world. The user has a sense of immersion by feeling these virtual spaces.

Unlike virtual reality, Augmented Reality (AR) is a technology that enables users to obtain various additional information through virtual objects in the real world by showing virtual objects seamlessly in real time. In other words, augmented reality is a computer graphics technique that synthesizes virtual objects in a real environment to make them look like objects in the original environment. Augmented reality (AR) is a live, direct or indirect, view of a physical, real-world environment whose elements are augmented by computer-generated sensory input such as visually perceivable content, including graphics, text, video, global position satellite (GPS) data or sound etc. Augmentation is conventionally in real-time and in semantic context with environmental elements, for example, addition of current, real-time sports scores to a non-related news feed. Advanced augmentation such as the use of computer vision, speech recognition and object recognition allows information about the surrounding real-world to be interactive and manipulated digitally. In many cases, information about the environment is visually overlaid on the images of the perceived real-world.

Some augmented reality devices rely, at least in part, on a head-mounted display, for example, with sensors for sound recognition. An example of existing head-mounted display technology or augmented reality glasses (AR glasses) uses transparent glasses which may include an electro-optic device and a pair of transparent lenses, which display information or images displayed over a portion of a user's visual field while allowing the user to perceive the real-world. The displayed information and/or images can provide supplemental information about a user's environment and objects in the user's environment, in addition to the user's visual and audio perception of the real-world.

The AR functionalities are useful for helping understand the context, size, and associative properties of products, tangible objects and other assets in a real world environment. Hence, augmented reality is useful for digital platforms such as including but not limited to e-commerce platforms. More specifically, today, in a typical online transaction via an e-commerce/digital platform, a consumer/user orders a product or service without understanding the true visuals, size, fit, finish or other physical characteristics of the product. The customer has to rely only upon previously generated media such as videos and imagery to make a decision and then has to fill out various fields in an order form before completing the checkout. The Augmented Reality techniques can make this user journey significantly simpler in understanding context on the object prior to purchase. Also, augmented reality e-commerce can be useful across multiple contexts for services that offer products digitally.

However, currently, the known solutions fails to effetely and efficiently invoke augmented reality functionality inside existing digital platforms and there are no current solutions which provides a solution to invoke, access and launch a camera linked to a digital platform, and one or more augmented reality capabilities, through a gesture or user-invoked command. Also, the current known solutions fails to provide a solution to invoke an augmented reality functionality for a digital platform based on enabling of a camera functionality on an electronic device using one or more gestures. Therefore, there exists a need in the art for a solution that provides user convenience in accessing Augmented Reality and/or Camera functions through an availability of one or more gestures or fields, for performing digital actions in AR environment, such as conducting online pre-transaction consideration steps (such as Virtual Try Ons and View in Your space etc.), facilitating financial aspects of an online transaction in a secure manner and/or the like digital actions in AR environment. Therefore, there is need in the art to provide a system and method to provide an augmented reality environment for a digital platform.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for providing an augmented reality environment for a digital platform. Another object of the present invention is to provision a universal method to invoke, access and launch a camera unit associated with a digital platform, and one or more augmented reality capabilities through one or more gestures or user-invoked commands that are consistent across all digital platforms and hardware that it is represented upon. Also, an object of the present invention is to help provide a methodology to personalize, represent, augment and auto-authenticate a user through a session when viewing an object in 3D or augmented reality environment. Also, an object of the present invention is to provide a method for on-line and in-store shopping using an augmented reality data processing environment to enhance on-line and in-store shopping. Yet another object of the present invention is to enable e-commerce transactions, information dissemination by providing a method of access through means such as Augmented Reality environment invoked by one or more gestures.

Furthermore, in order to achieve the aforementioned objectives, the present invention provides a method and system for providing an augmented reality environment for a digital platform. In an implementation the digital platform is an e-commerce platform.

A first aspect of the present invention relates to the method for providing an augmented reality environment for a digital platform. The method encompasses receiving, at a transceiver unit from an electronic device, a user input via the digital platform, wherein the user input comprises at least one camera invoking gesture. The method thereafter comprises enabling, by a processing unit, a camera functionality of a camera unit of the electronic device, based on the camera invoking gesture. Further the method encompasses receiving, by the processing unit from one or more sensors, a surrounding environment data based on the enabled camera functionality. Further the method comprises generating, by the processing unit, the augmented reality environment associated with the digital platform, based on the surrounding environment data.

Another aspect of the present invention relates to a system for providing an augmented reality environment for a digital platform. The system comprises a transceiver unit, configured to receive from an electronic device, a user input via the digital platform, wherein the user input comprises at least one camera invoking gesture. The system further comprises a processing unit, configured to enable, a camera functionality of a camera unit of the electronic device, based on the camera invoking gesture. The processing unit is further configured to receive, from one or more sensors, a surrounding environment data based on the enabled camera functionality. Also, the processing unit is thereafter configured to generate, the augmented reality environment associated with the digital platform, based on the surrounding environment data.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for providing an augmented reality environment for a digital platform, in accordance with exemplary embodiments of the present invention.

FIG. 2 illustrates an exemplary method flow diagram [200], depicting a method for providing an augmented reality environment for a digital platform, in accordance with exemplary embodiments of the present invention.

FIG. 3 illustrates an exemplary use case in accordance with exemplary embodiments of the present invention.

FIG. 4 illustrates an exemplary use case in accordance with exemplary embodiments of the present invention.

The foregoing shall be more apparent from the following more detailed description of the disclosure.

### DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a device”, “an augmented reality (AR) device”, “an AR hardware”, “an augmented reality computing device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device (such as smart glasses, smart watches etc.), projection device or any other computing device having properties of processing, storage and camera enablement or which is capable of implementing the features of the present disclosure. Also, the user device may contain at least one input means configured to receive an input from a user, a processing unit, a storage unit, a display unit, a transceiver unit, a camera unit, one or more sensors and/or any other such unit(s) which are obvious to the person skilled in the art and are capable of implementing the features of the present disclosure. Also, in an implementation the user/electronic device is connected over a network, wherein the network can be, for example, a telecommunications network, a local area network (LAN), a wide area network (WAN), a virtual local area network (VLAN) such as the Internet, or any combination of the three, and can include wired, wireless, or fiber optic connections. In general, network can be any combination of connections and protocols that will support communications between the electronic device, the digital platform and one or more gestures to implement the features of the present invention. Furthermore, in an exemplary implementation, the AR hardware/electronic device may be an augmented reality computing device implemented as a wearable computer or a handheld smartphone. The wearable computers such as the described AR hardware are especially useful for applications that require more complex computational support than just hardware coded logics. In general, the AR hardware represents a programmable electronic device, a computing device or a combination of programmable electronic devices capable of executing machine readable program instructions and communicating with other computing devices via a network. Also, in an implementation a digital image capture technology such as a digital camera or image scanning technology may be provided with the AR hardware, in addition to digital image projection to the user in AR hardware, creating the augmented reality standard in augmented reality device technology. Also, in an implementation, the AR hardware, includes an e-commerce platform logic, e-commerce 3D digital asset manager database, and a user interface (UI). The AR hardware may include internal and external hardware components that are purpose built or included for the purpose of Augmentation or Augmented Reality. This includes but is not limited to Lidar sensors, flood illuminators, Infrared projectors, laser time of flight sensors and additional optical, sensorial or visual enhancing components.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions. Also, in an implementation the storage unit may be server such as a management server, a web server, or any other electronic device or computing system comprising a database and capable of receiving and sending data. In other implementation, the server may represent a server computing system utilizing multiple computers as a server system, which may be a distributed computing environment created by clustered computers and components acting as a single pool of seamless resources such as a cloud computing environment. In another implementation, the server may be a laptop computer, a netbook computer, a personal computer (PC), a desktop computer, a personal digital assistant (PDA), a smart phone, or any programmable electronic device capable of communicating with AR hardware/devices and/or one or more sensors to implement the features of the present invention. Furthermore, in another implementation, the database may reside in a device within an augmented reality data processing environment accessible via a network. The database may be implemented with any type of storage device capable of storing data that may be accessed and utilized to perform functions of the present invention, such as a database server, a hard disk drive, or a flash memory etc. In other implementation, the database may represent multiple storage devices within a storage server. In another implementation, the database is a store database such as an on-line product catalog. The database may include one or more object information such as product images, product names, product specifications and/or product attributes including product availability and barcode information or a product barcode. A digital platform within an augmented reality data processing environment, for example, an e-commerce platform on AR glasses, may access database which may be any database including any store database, multi-vendor database, multiple advertisement database, or product database etc. The e-commerce platform may retrieve information on an object or product from database via the network.

As used herein the “Transceiver Unit” may include but not limited to a transmitter to transmit data to one or more destinations and a receiver to receive data from one or more sources. Further, the Transceiver Unit may include any other similar unit obvious to a person skilled in the art, to implement the features of the present invention. The transceiver unit may convert data or information to signals and vice versa for the purpose of transmitting and receiving respectively.

As disclosed in the background section the existing technologies have many limitations and in order to overcome at least some of the limitations of the prior known solutions, the present disclosure provides a solution for providing an augmented reality environment for a digital platform. Further, to provide the AR environment for the digital platform via an electronic device (such as a wearable device or a smartphone), the present invention provides a solution to invoke a camera unit connected to the electronic device based on one or more gestures, wherein the camera unit is further associated with the digital platform. Also, in an implementation the digital platform is an e-commerce platform accessed via the electronic device. More specifically, in said implementation the present invention provides a solution to invoke the functionality of augmenting products inside an e-commerce platform for consideration and transaction.

Furthermore, to implement the features of the present invention, a system is provided for a user to access through the electronic device (i.e. the smartphone or the wearable device) in order to invoke a command or gesture or access control to perform one or more actions (such as to view, select etc.) on desired objects through augmented reality technologies. Further, the present invention also encompasses use of surrounding environmental data that includes at least a spatial data or image data received from one or more sensors, and said data can further be accessed through one or more gestures performed by the user for augmented reality product instructions, tutorials, visualizations and the like information related to the digital platform in AR environment. Also, for providing an information related to the digital platform in the AR environment, the present invention encompasses receiving a request for information from the electronic device, and in an event the request comprises an image data and a request type. Thereafter, in such event the present invention encompasses converting, the image data into a digital fingerprint. This fingerprint is then utilized to compare to a plurality of recommendations, assets and/or additional information, to provide a relevant information in response to the request for information in the AR environment.

Furthermore, to perform the one or more gestures, in an implementation the present invention encompasses use of one or more tactile and/or audio commands. For example, touch screens, in smart phones or touch sensors on AR glasses, may be used in conjunction to or as an alternative to command the smart phones/AR glasses. Also, in another implementation, to perform the one or more gestures, the present invention encompasses use of gaze focal point detection, for instance, an object may be identified by identifying a focal point in the user's field of vision. In yet another implementation, to perform the one or more gestures, the present invention encompasses use of one or more muscle movements such as a finger motion or a hand gesture. Also, in order to identify the one or more gestures, the electronic devices are coupled with one or more sensors. The one or more sensors detects one or more sensor data to further detect the one or more gestures. Further, in an example, the one or more gestures correlated to the one or more sensor data received by the electronic device correspond to one or more user command, for example, a gesture associated with sensor data for one or more muscle movements may be configured to select an object or product.

Furthermore, the present invention also provide a capability perform one or more actions such as to identify a selected object or product in an augmented reality view, such as an internet site or an on-line store database viewed using the electronic device such as AR glasses. Also, in an implementation, the present invention encompasses providing an ability to view or scan barcode data of a product in a real world environment such as a brick and mortar store. Additionally, in another implementation the present invention provides an ability to capture an image of an object in a real world environment such as a brick and mortar store for performing the one or more actions such as possible selection, identification, shopping cart addition, and other object related actions, in the AR environment via the one or more gestures. Also, the present invention provides a capability to perform the one or more actions such as to search product data, to search product attributes, to search multiple websites, local or on-line databases and real world environments etc., to select an object or product, to move an object or product to an on-line or augmented reality shopping cart for purchase and to store and retrieve selected products and search results using the electronic device such as the AR glasses in the AR environment by performing the one or more gestures. Also, the present invention provides a memory management function, for recall of data on previously viewed or searched objects or products such as product images, product identification, product attributes, product type and product location, in the AR environment.

Hereinafter, exemplary embodiments of the present disclosure will be described in detail with reference to the accompanying drawings so that those skilled in the art can easily carry out the present disclosure.

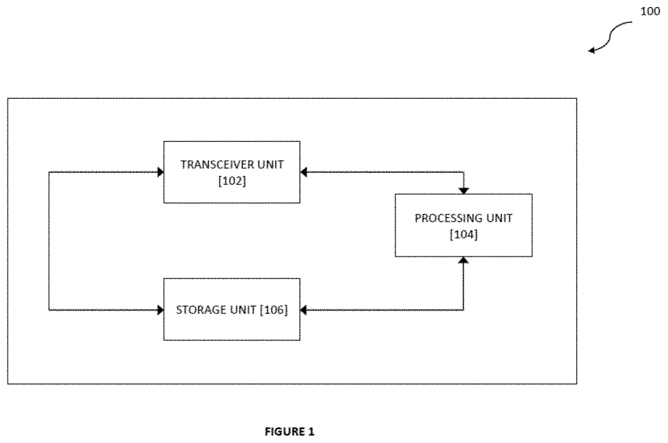

Referring to FIG. 1, an exemplary block diagram of a system [100] for providing an augmented reality environment for a digital platform, in accordance with exemplary embodiments of the present invention is shown. The digital platform can be accessed via an electronic device and in an implementation the digital platform is an e-commerce platform.

The system [100] comprises at least one transceiver unit [102], at least one processing unit [104] and at least one storage unit [106]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] is connected to an electronic device of a user to implement the features of the present invention.

The system [100] is configured to provide, an augmented reality environment for a digital platform, with the help of the interconnection between the components/units of the system [100].

The transceiver unit [102] of the system [100] is configured to receive from the electronic device via the digital platform, one or more gestures corresponding to one or more user commands to perform one or more operations on the digital platform. The one or more gestures may include but not limited to at least one of a camera invoking gesture, a selection gesture, an action gesture. In an implementation a user gesture (such as a camera invoking gesture to enable a camera unit) may be, for example, created/configured by a user upon initialization of the digital platform (such as an e-commerce platform), stored/configured by the user prior to use of the digital platform, or configured by the user as a default setting to perform a particular action on the digital platform. More particularly, for configuration of the one or more gestures corresponding to the one or more user commands, the processing unit [104] of the system [100] is configured to receive one or more sensor data from one or more sensors to detect and track the one or more gestures. Further, the processing unit [104] based on a user input, may configure the one or more gestures to correspond to the one or more user command to perform the one or more actions on the digital platform (such as an e-commerce platform). For instance, common tasks used in e-commerce, such as drag and drop of a product to add, change a quantity, or remove the product from a virtual shopping cart, and complete a purchase, for example, may be initially configured and correlated by the processing unit [104] based on a user input, to specific gestures detected by the electronic device. When the user initially configures the e-commerce platform, the processing unit [104] is configured to send the one or more sensor data, to a network for further utilization. In another implementation, upon receiving the one or more sensor data for the one or more gestures, the processing unit [104] based on the user input may direct the e-commerce platform to configure the one or more user commands to be executed in response to the one or more gestures.

Furthermore, in an implementation for providing the augmented reality environment for the digital platform, the transceiver unit [102] is configured to receive from the electronic device, a user input via the digital platform, wherein the user input comprises at least one camera invoking gesture. Further the at least one camera invoking gesture is associated with at least one user command to enable a camera unit of the electronic device. Also, the at least one camera invoking gesture is based on at least one of one or more tactile commands, one or more audio commands, one or more gaze focal point detection techniques, one or more logics and one or more muscle movements. Furthermore, the one or more tactile commands may include one or more tap based commands (such as single tap, double tap etc.), the one or more swipe based commands (left swipe, bottom swipe etc.) and the like. The one or more tap based commands may be invoked with user interface elements such as buttons and CTA areas. The one or more swipe based commands may be invoked with a single stroke, or multiple stroke based swipes. Also, the one or more audio commands may be invoked based on recognition of on one or more voice inputs received via one or more microphone sensors. Further, the one or more gaze focal point detection techniques can be invoked based on a user tracked eye-movement and gaze. Also, the one or more logics may be invoked based on a successful completion of a game logic and the like logic. Further, the one or more muscle movements may be associated with one or more pose based gestures and the one or more pose based gestures may be invoked based on a pose and/or a movement data received from one or more gyroscope and accelerometer sensors in a particular motion.

The processing unit [104], configured to enable, a camera functionality of the camera unit of the electronic device, based on the camera invoking gesture. The camera unit of the electronic device is further linked to the digital platform. For example, the camera functionality of the camera unit of the electronic device may be enabled based on at least one of a tactile command based camera invoking gesture, an audio command based camera invoking gesture, a gaze focal point detection technique based camera invoking gesture, a logic based camera invoking gesture, a muscle movement based camera invoking gesture and the like.

Once the camera unit is enabled, the processing unit [104] is configured to receive, from the one or more sensors, a surrounding environment data based on the enabled camera functionality. For example, the surrounding environment data such as one or more environmental parameters relating to surrounding lightning conditions, surrounding view, surrounding objects and the like are received as one or more sensor data from the one or more sensors. Thereafter, the processing unit [104] is configured to generate, the augmented reality environment associated with the digital platform, based on the surrounding environment data. More specifically, the augmented reality environment is generated based on the surrounding environment data and the enabled camera functionality of the camera unit linked to the digital platform. Also, the augmented reality environment displays one or more properties of the surrounding environment and the one or more features/functionalities of the digital platform.

Also, the processing unit [104] is further configured to provide, at least one recommendation in the generated augmented reality environment, based on a pre-trained dataset. The pre-trained dataset comprises a plurality of data trained based at least on a plurality of products. In an implementation the processing unit [104] is further configured to provide the at least one recommendation in the generated augmented reality environment based on at least one of a user intent, a user preference, a user historical data and the surrounding environment data. For example, in an augmented reality environment of e-commerce platform one or more products and/or services are recommended to the user based on determination of one or more relevant products/services for the user. Further, the one or more relevant products/services are determined based on at least one of the pre-trained dataset, the user intent, the user preference, the user historical data and the surrounding environment data. In one another example, a recommendation in the augmented reality environment of the e-commerce platform may be a 3D Red ABC shirt, wherein the Red ABC shirt is determined as a relevant product for the user based on the pre-trained dataset comprising details of various red shirts of ABC brand, a determined user preference of wearing a red shirt of ABC brand and a determined intent of the user to buy a red shirt of ABC brand.

Further, the transceiver unit [102] is configured to receive, the selection gesture for selecting the at least one recommendation in the generated augmented reality environment. The selection gesture is based on at least one of the one or more tactile commands, the one or more audio commands, the one or more gaze focal point detection techniques, the one or more logics and the one or more muscle movements. Furthermore, the one or more tactile commands may include the one or more tap based commands (such as the long press, short press, single tap, point finger tap in AR environment etc.), the one or more swipe based commands (left swipe, bottom swipe etc.) and the like. The one or more tap based commands may be invoked with user interface elements such as the one or more buttons and the one or more CTA areas. The one or more swipe based commands may be invoked with the single stroke, or the multiple stroke based swipes. Also, the one or more audio commands may be invoked based on recognition of the one or more voice inputs received via the one or more microphone sensors. Further, the one or more gaze focal point detection techniques can be invoked based on the user tracked eye-movement and the gaze. Also, the one or more logics may be invoked based on the successful completion of the game logic and the like logic. Further, the one or more muscle movements may be associated with one or more pose based gestures and the one or more pose based gestures may be invoked based on the pose and/or the movement data received from one or more gyroscope and accelerometer sensors in a particular motion.

Also, the processing unit [104] is further configured to automatically select in the generated augmented reality environment, the at least one recommendation based on the selection gesture. For example, the at least one recommendation may be automatically selected based on at least one of a tactile command based selection gesture, an audio command based selection gesture, a gaze focal point detection technique based selection gesture, a logic based selection gesture, a muscle movement based selection gesture and the like. Also, in another example, if one pair of ABC shoe and one pair of XYZ shoe are recommended in 3D in the augmented reality environment of the e-commerce platform, the processing unit may be configured to select at least one of the pair of ABC shoe and the pair of XYZ shoe based on at least one of the tactile command based selection gesture, the audio command based selection gesture, the gaze focal point detection technique based selection gesture, the logic based selection gesture, the muscle movement based selection gesture and the like gesture.

Further, the transceiver unit [102] is also configured to receive a request for information associated with at least one object in the generated augmented reality environment. The at least one object comprises at least one of one or more products, one or more persons and one or more buildings. For example, the request for information may be a request for information of ABC laptop and in such example, the transceiver unit [102] is configured to receive the request for information of the ABC laptop in an augmented reality environment generated for an e-commerce platform.

Also, the processing unit [104] is further configured to provide in the generated augmented reality environment, a first set of data based on the received request for information associated with the at least one object. Furthermore, considering the above example where the request for information of the ABC laptop is received, the processing unit [104] is further configured to provide/display in the generated augmented reality environment for the e-commerce platform, one or more products similar to ABC laptop in 3D, based on the received request for received request. Also, in the given example the first set of data is the one or more products similar to ABC laptop in a 3D view. In an example, the first set of data is shown across a backlit display in a smartphone using a telemetry data and visual data from camera modules. If the first set of data is to be placed in front of the user, in free space, the rear camera is invoked. If the first set of data has to be placed on the user as an augmentation on the user's body, the processing unit [104] invokes the front facing camera on the smartphone. In an example, if the electronic device is a wearable device such as a pair of AR glasses, a holographic representation of the user is provided through displays such as pass-through AR displays or waveguides.

Thereafter, the transceiver unit [102] is further configured to receive at least one action gesture for performing one or more actions on the first set of data, in the generated augmented reality environment. The at least one action gesture is based on at least one of the one or more tactile commands, the one or more audio commands, the one or more gaze focal point detection techniques, the one or more logics and the one or more muscle movements. Furthermore, the one or more tactile commands may include the one or more tap based commands (such as the long press, short press, single tap etc.), the one or more swipe based commands (left swipe, bottom swipe etc.) and the like. The one or more tap based commands may be invoked with user interface elements such as the one or more buttons and the one or more CTA areas. The one or more swipe based commands may be invoked with the single stroke, or the multiple stroke based swipes. Also, the one or more audio commands may be invoked based on recognition of the one or more voice inputs received via the one or more microphone sensors. Further, the one or more gaze focal point detection techniques can be invoked based on the user tracked eye-movement and the gaze. Also, the one or more logics may be invoked based on the successful completion of the game logic and the like logic. Further, the one or more muscle movements may be associated with one or more pose based gestures and the one or more pose based gestures may be invoked based on the pose and/or the movement data received from one or more gyroscope and accelerometer sensors in a particular motion. Further, in an example, the one or more pose based gestures may further provide user gestures or motions such as a finger motion or an arm motion associated to display/select/move an augmented reality object or asset as requested by a user, in an AR environment. Also, in another example, the processing unit [104] may be configured to select an object using a gesture such as a nod of the head detected by the one or more sensors in AR Hardware such as AR Glasses. Also, in an example, the processing unit [104] allows a user to select an object using gaze focal point tracker capability. For example, in the case of AR Hardware being exclusively a wearable device, the processing unit [104] may select an object with a gaze focal point tracker which uses the direction of a user gaze and binocular vision principles to extrapolate a focal point of the user's vision. In alternative, the processing unit [104], with gaze tracker may be configured to select an object based on a threshold period of time the user focuses on the object.

Also, the processing unit [104] is further configured to automatically perform in the generated augmented reality environment, the one or more actions on the first set of data based on the at least one action gesture. For example, the one or more actions on the first set of data are automatically performed based on at least one of a tactile command-based action gesture, an audio command-based action gesture, a gaze focal point detection technique based action gesture, a logic based action gesture, a muscle movement based action gesture and the like gesture. Also, the one or more actions comprises one or more actions that can be performed on the digital platform, for example, for an e-commerce platform the one or more actions may include but not limited to selection of a product, adding a product to a cart, marking a product favorite, scrolling various products, filtering various products based on various filters, purchasing one or more products, performing financial transactions, reviewing a product, returning a product and the like actions. Also, in another example, if one XYZ T-shirt and one CBA T-Shirt are provided as a first set of data in 3D in the augmented reality environment of the e-commerce platform, the processing unit [104] may be configured to add to a virtual cart of the e-commerce platform, at least one of the XYZ T-shirt and the CBA T-Shirt based on at least one of the tactile command based action gesture, the audio command based action gesture, the gaze focal point detection technique based action gesture, the logic based action gesture, the muscle movement based action gesture and the like gesture. Furthermore, in one example, if an action performed is an automatic selection of one or more objects, the processing unit [104] may be configured to retrieve a stored data associated with one or more selected objects in a reverse order in which the objects were selected or, in other words, retrieve the one or more objects by sequential order of entry starting from the most recent object to the oldest selected object. In another example, the processing unit [104] may retrieve from the storage unit [106], a data stored by a category. For example, a data stored by the user may be searched by a user or other defined category such as a product type in the storage unit [106]. For example, a user may select to retrieve data associated with each object previously selected in a product type or category. Upon the user completing a review the retrieved data viewed by the user, the processing unit [104] may be configured to determine whether another object is selected by the user.

Also, in an implementation, the processing unit [104] is further configured to automatically perform in the generated augmented reality environment, the one or more actions on the first set of data based on the one or more auto authentication options. The one or more auto authentication options are one or more techniques to authenticate the user on the digital platform, wherein the one or more techniques includes but not limited to at least one of a finger print recognition, a facial recognition, an eye based recognition, gesture based recognition and the like techniques. Also, in an example, to buy a smartphone in a generated augmented reality environment of an e-commerce platform, the processing unit [104] is configured to perform a transaction based on authentication of the user via the facial recognition technique. In another example if the user has successfully added an object to cart, the processing unit [104] is configured to verify the user's identity in the generated AR environment. This may include launching of a front facing camera during the AR session or a post-cart addition session so that the user can derive a frictionless purchase experience. This auto authentication experience includes at least face recognition and a tracking required to verify the identity of the user. If there is no prior authentication information available, in an implementation, a code, password, login or additional-factor authentication can be provisioned as an overlay in the augmented reality environment or post-augmentation. In a scenario of successful completion the example proceeds to a completion of the user purchase intent. In the scenario of a failure to authenticate the user, the example proceeds to re-verify user authentication.

Furthermore, in an implementation, the processing unit [104] is further configured to generate, a personalized first set of data based on at least one of the user preference, the user historical data and the surrounding environment data, wherein the personalized set of data is further generated by modifying at least one parameter associated with the first set of data. More specifically, the processing unit [104] is configured to change the at least one parameter such as one or more properties of the first set of data in accordance with a user data such as the user preference, the user historical data and the surrounding environment data of the user. In an implementation the one or more properties of the first set of data can be mapped to a user across existing data gathering and user information tools, such that such attributes, properties, values, tags, variants and/or word clouds can be utilized to influence the properties of the 3D first set of data to be shown in the generated Augmented Reality environment. Further, in an example, if a first set of data comprises one or more chairs, the processing unit [104] is further configured to generate the personalized first set of data, wherein the personalized first set of data comprises one or more personalized chairs. Also, in such example the one or more personalized chairs are one or more chair of preferred color of a user (determined based on a user preference), one or more chair of specific color (determined based on a purchase history of the user) and/or one or more chair of surrounding environment matching color (determined based on a surrounding environment data of the user). Also, in the given example, the processing unit [104] is configured to change the color of the one or more chair (i.e. modify the color parameter associated with the one or more chair) in the real time.

Also, the processing unit [104] is further configured to provide, the personalized first set of data in the generated augmented reality environment. More particularly, once the personalized first set of data is generated, the processing unit [104] is configured to display the personalized first set of data in 3D view in the generated augmented reality environment. Further, considering the above example, the processing unit [104] is further configured to display the one or more personalized chairs in the 3D view in the generated augmented reality environment.

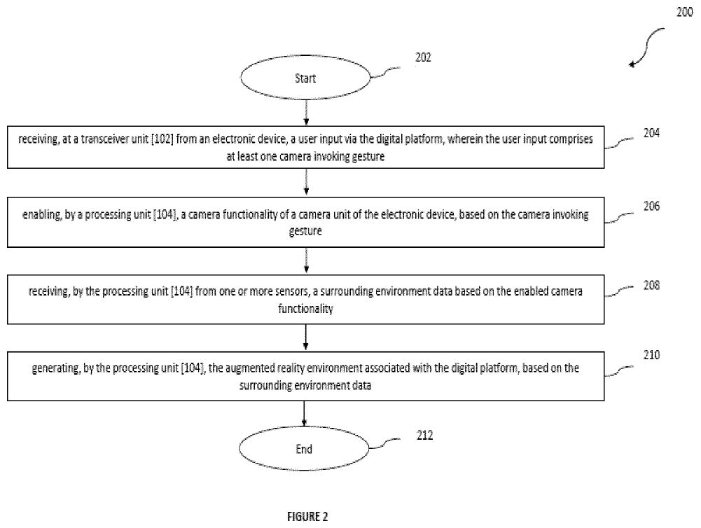

Referring to FIG. 2, an exemplary method flow diagram [200], depicting a method for providing an augmented reality environment for a digital platform, in accordance with exemplary embodiments of the present invention is shown. In an implementation the method is performed on an electronic device by system [100] and the digital platform is accessed on the electronic device. Also, in an implementation the digital platform is an e-commerce platform. Also, as shown in FIG. 2, the method starts at step [202].

The method encompasses receiving at a transceiver unit [102] from the electronic device via the digital platform, one or more gestures corresponding to one or more user commands to perform one or more operations on the digital platform. The one or more gestures may include but not limited to at least one of a camera invoking gesture, a selection gesture, an action gesture. In an implementation a user gesture may be, for example, configured by a user upon initialization of the digital platform (such as an e-commerce platform), configured by the user prior to use of the digital platform, or configured by the user as a default setting to perform a particular action on the digital platform. More particularly, for configuration of the one or more gestures corresponding to the one or more user commands, the method encompasses receiving at a processing unit [104], one or more sensor data from one or more sensors to detect and track the one or more gestures. Further, the method encompasses configuring by the processing unit [104] based on a user input, the one or more gestures to correspond to the one or more user command to perform the one or more actions on the digital platform (such as an e-commerce platform). For instance, common tasks used in e-commerce (such as drag and drop of a product to add, change a quantity, or remove the product from a virtual shopping cart, and complete a purchase), may be initially configured and correlated by the processing unit [104] based on a user input, to specific gestures detected by the electronic device. When the user initially configures the e-commerce platform, the method encompasses sending by the processing unit [104], the one or more sensor data, to a network for further utilization. In another implementation, upon receiving the one or more sensor data for the one or more gestures, the method encompasses directing by the processing unit [104], the e-commerce platform to configure the one or more user commands to be executed in response to the one or more gestures, based on the user input.

Furthermore, in an implementation for providing the augmented reality environment for the digital platform, at step [204] the method comprises receiving, at a transceiver unit [102] from the electronic device, a user input via the digital platform, wherein the user input comprises at least one camera invoking gesture. Further the at least one camera invoking gesture is associated with at least one user command to enable a camera unit of the electronic device. Also, the at least one camera invoking gesture is based on at least one of one or more tactile commands, one or more audio commands, one or more gaze focal point detection techniques, one or more logics and one or more muscle movements. Furthermore, the one or more tactile commands may include one or more tap based commands (such as single tap, double tap etc.), the one or more swipe based commands (left swipe, bottom swipe etc.) and the like. The one or more tap based commands may be invoked with user interface elements such as buttons and CTA areas. The one or more swipe based commands may be invoked with a single stroke, or multiple stroke based swipes. Also, the one or more audio commands may be invoked based on recognition of on one or more voice inputs received via one or more microphone sensors. Further, the one or more gaze focal point detection techniques can be invoked based on a user tracked eye-movement and gaze. Also, the one or more logics may be invoked based on a successful completion of a game logic and the like logic. Further, the one or more muscle movements may be associated with one or more pose based gestures and the one or more pose based gestures may be invoked based on a pose and/or a movement data received from one or more gyroscope and accelerometer sensors in a particular motion.

Further at step [206] the method comprises enabling, by the processing unit [104], a camera functionality of the camera unit of the electronic device, based on the camera invoking gesture. The camera unit of the electronic device is further linked to the digital platform. Also, the at least one camera invoking gesture is based on at least one of one or more tactile commands, one or more audio commands, one or more gaze focal point detection techniques, one or more logics, one or more muscle movements and the like commands.

Once the camera unit is enabled, at step [208], the method comprises receiving, by the processing unit [104] from one or more sensors, a surrounding environment data based on the enabled camera functionality. For example, the surrounding environment data such as one or more environmental parameters relating to surrounding lightning conditions, surrounding view, surrounding objects and the like are received as one or more sensor data from the one or more sensors. Further the method at step [210] comprises generating, by the processing unit [104], the augmented reality environment associated with the digital platform, based on the surrounding environment data. More specifically, the augmented reality environment is generated based on the surrounding environment data and the enabled camera functionality of the camera unit linked to the digital platform. Also, the augmented reality environment displays one or more properties of the surrounding environment and the one or more features/functionalities of the digital platform.

Also, the method further comprises providing, by the processing unit [104], at least one recommendation in the generated augmented reality environment, based on a pre-trained dataset. The pre-trained dataset comprises a plurality of data trained based at least on a plurality of products. Also, in an implementation the step of providing, by the processing unit [104], the at least one recommendation in the generated augmented reality environment is further based on at least one of a user intent, a user preference, a user historical data and the surrounding environment data. For example, in an augmented reality environment of e-commerce platform one or more products are recommended to the user based on determination of one or more relevant products for the user. Further, the one or more relevant products are determined based on at least one of the pre-trained dataset, the user intent, the user preference, the user historical data and the surrounding environment data. In one another example, a recommendation in the augmented reality environment of the e-commerce platform may be a Black AAA Jacket in a 3D view, wherein the Black AAA Jacket is determined as a relevant product for the user based on the pre-trained dataset comprising details of various black jackets of AAA brand and a determined intent of the user to buy a black Jacket of AAA brand.

Thereafter, the method encompasses receiving, at the transceiver unit [102], a selection gesture for selecting the at least one recommendation in the generated augmented reality environment. The selection gesture is based on at least one of the one or more tactile commands, the one or more audio commands, the one or more gaze focal point detection techniques, the one or more logics and the one or more muscle movements. Furthermore, the one or more tactile commands may include the one or more tap based commands (such as the long press, short press, single tap, point finger tap in AR environment etc.), the one or more swipe based commands (left swipe, bottom swipe etc.) and the like. In an example, the one or more tap based commands may be invoked with user interface elements such as the one or more buttons and the one or more CTA areas. The one or more swipe based commands may be invoked with the single stroke, or the multiple stroke based swipes. Also, the one or more audio commands may be invoked based on recognition of the one or more voice inputs received via the one or more microphone sensors. Further, the one or more gaze focal point detection techniques can be invoked based on the user tracked eye-movement and the gaze. Also, the one or more logics may be invoked based on the successful completion of the game logic and the like logic. Further, the one or more muscle movements may be associated with one or more pose based gestures and the one or more pose based gestures may be invoked based on the pose and/or the movement data received from one or more gyroscope and accelerometer sensors in a particular motion.

Further, the method comprises automatically selecting in the generated augmented reality environment, by the processing unit [104], the at least one recommendation based on the selection gesture. For example, the at least one recommendation may be automatically selected based on at least one of a tactile command based selection gesture, an audio command based selection gesture, a gaze focal point detection technique based selection gesture, a logic based selection gesture, a muscle movement based selection gesture and the like. Also, in another example, if 10 smartphones are recommended in 3D in the augmented reality environment of the e-commerce platform, the method encompasses selecting via the processing unit [104], at least one smartphone from the 10 smartphones based on at least one of the tactile command based selection gesture, the audio command based selection gesture, the gaze focal point detection technique based selection gesture, the logic based selection gesture, the muscle movement based selection gesture and the like gesture. Furthermore, the method also comprises receiving, at the transceiver unit [102], a request for information associated with at least one object in the generated augmented reality environment. The at least one object comprises at least one of one or more products, one or more persons and one or more buildings. For example, the request for information may be a request for information of ABC building and in such example, the method encompasses receiving at the transceiver unit [102], the request for information of the ABC building in an augmented reality environment generated for a digital platform.

Thereafter, the method comprises providing in the generated augmented reality environment, by the processing unit [104], a first set of data based on the received request for information associated with the at least one object. Furthermore, considering the above example where the request for information of the ABC building is received, the method encompasses displaying by the processing unit [104], in the generated augmented reality environment for the digital platform, one or more details (such as interior details/images, height details, location details) related to the ABC building in 3D, based on the received request for received request. Also, in the given example the first set of data is the one or more details related to the ABC building in a 3D view.

Also, the method further comprises receiving, at the transceiver unit [102], at least one action gesture for performing one or more actions on the first set of data, in the generated augmented reality environment. Also, the at least one action gesture is based on at least one of the one or more tactile commands, the one or more audio commands, the one or more gaze focal point detection techniques, the one or more logics and the one or more muscle movements. Furthermore, the one or more tactile commands may include the one or more tap based commands (such as the long press, short press, single tap etc.), the one or more swipe based commands (left swipe, bottom swipe etc.) and the like. The one or more tap based commands may be invoked with user interface elements such as the one or more buttons and the one or more CTA areas. The one or more swipe based commands may be invoked with the single stroke, or the multiple stroke based swipes. Also, the one or more audio commands may be invoked based on recognition of the one or more voice inputs received via the one or more microphone sensors. Further, the one or more gaze focal point detection techniques can be invoked based on the user tracked eye-movement and the gaze. Also, the one or more logics may be invoked based on the successful completion of the game logic and the like logic. Further, the one or more muscle movements may be associated with one or more pose based gestures and the one or more pose based gestures may be invoked based on the pose and/or the movement data received from one or more gyroscope and accelerometer sensors in a particular motion. Further, in an example, the one or more pose based gestures may further provide user gestures or motions such as a finger motion or an arm motion associated to display/select/move an augmented reality object/s or asset/s as requested by a user, in an AR environment. Also, in another example, the method encompasses selecting by the processing unit [104], an object using a gesture such as a pointing of a finger towards the object, detected by the one or more sensors connected to the AR Hardware.

The method thereafter encompasses automatically, performing in the generated augmented reality environment, by the processing unit [104], the one or more actions on the first set of data based on the at least one action gesture. For example, the one or more actions on the first set of data are automatically performed based on at least one of a tactile command-based action gesture, an audio command-based action gesture, a gaze focal point detection technique based action gesture, a logic based action gesture, a muscle movement based action gesture and the like gesture. Also, the one or more actions comprises one or more actions that can be performed on the digital platform, for example, for an e-commerce platform the one or more actions may include but not limited to selection of a product, adding a product to a cart, marking a product favorite, scrolling various products, filtering various products based on various filters, purchasing one or more products, performing financial transactions, reviewing a product, returning a product, comparing two or more products and the like actions. Also, in another example, if one XYZ watch and one CBA watch are provided as a first set of data in 3D in the augmented reality environment of the e-commerce platform, the method encompasses moving by the processing unit [104] in a wish list category of the e-commerce platform, at least one of the XYZ watch and the CBA watch based on at least one of the tactile command based action gesture, the audio command based action gesture, the gaze focal point detection technique based action gesture, the logic based action gesture, the muscle movement based action gesture and the like gesture.

Also, in an implementation the process of automatically, performing in the generated augmented reality environment, by the processing unit [104], the one or more actions on the first set of data is further based on the one or more auto authentication options. The one or more auto authentication options are one or more techniques to authenticate the user on the digital platform, wherein the one or more techniques includes but not limited to at least one of a finger print recognition, a facial recognition, an eye based recognition, gesture based recognition and the like techniques. Also, in an example, to buy a smartphone in a generated augmented reality environment of an e-commerce platform, the method encompasses performing by the processing unit [104], a transaction based on authentication of the user via the finger print recognition technique. In another example if the user has successfully added an object to cart via performing one or more gestures in the AR environment, the method encompasses verifying by the processing unit [104], the user's identity in the generated AR environment.

Furthermore, in an implementation the step of providing in the generated augmented reality environment, by the processing unit [104], the first set of data further comprises generating, by the processing unit [104], a personalized first set of data based on at least one of the user preference, the user historical data and the surrounding environment data, wherein the personalized set of data is further generated by modifying at least one parameter associated with the first set of data. More specifically, the method encompasses changing by the processing unit [104], the at least one parameter such as one or more properties of the first set of data in accordance with a user data such as the user preference, the user historical data and the surrounding environment data of the user. Further, in an example, if a first set of data comprises one or more eyeglasses, the method encompasses generating by the processing unit [104], the personalized first set of data, wherein the personalized first set of data comprises one or more personalized eyeglasses. Also, in such example the one or more personalized eyeglasses are one or more eyeglasses of preferred shape of a user (wherein the preferred shape is determined based on a user preference), one or more eyeglasses of specific shape (wherein the specific shape is determined based on a purchase history of the user) and/or one or more eyeglasses of shape according to face of the user (wherein the shape according to the face of the user is determined based on a surrounding environment data comprising image data of the user). Also, in the given example, the method encompasses changing by the processing unit [104], the shape of the one or more eyeglasses (i.e. modifying the shape parameter associated with the one or more eyeglasses) in the real time.

Thereafter in the above implementation, the method leads to providing, by the processing unit [104], the personalized first set of data in the generated augmented reality environment. More particularly, once the personalized first set of data is generated, the method encompasses displaying by the processing unit [104], the personalized first set of data in 3D view in the generated augmented reality environment. Further, considering the above example, the method encompasses displaying by the processing unit [104], the one or more personalized eyeglasses in the 3D view in the generated augmented reality environment.

The method thereafter terminates at step [212].

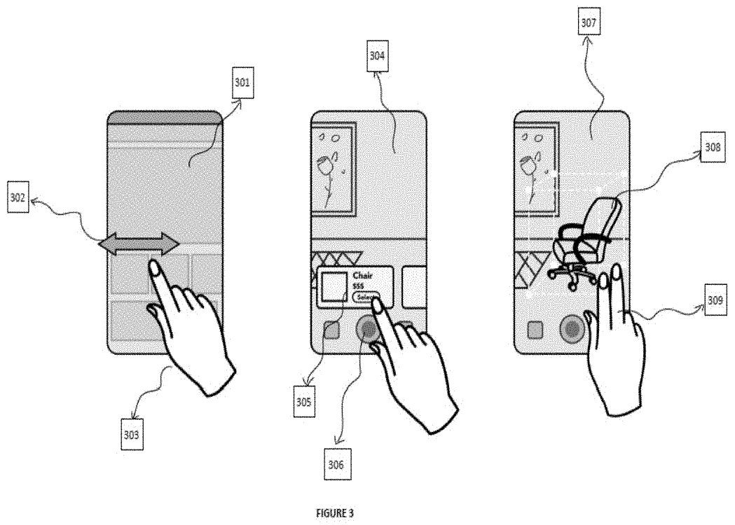

Referring to FIG. 3, an exemplary use case in accordance with exemplary embodiments of the present invention is shown. FIG. 3 illustrates possibilities of using one or more gesture in an AR environment generated for a digital platform based on the implementation of the features of the present invention. 301 represents an e-commerce platform (i.e. the digital platform) with digital products and their 3D information stored in a database. These objects and digital assets can be placed in the generated Augmented Reality environment for the e-commerce platform. Further, one or more actions can be performed on the e-commerce platform based on recognition of one or more gestures to perform the one or more operations on the e-commerce platform. When the user performs the gesture (i.e. 303), the e-commerce platform has the ability to then, augment the information and provide the user with a spatial understanding of the asset in consideration. More specifically, the FIG. 3 depicts the following steps:
301—E-commerce platform with CTAs
302—Gesture recognized by the e-commerce platform
303—Gesture being performed by the user
304—User's real world space
305—E-commerce platform CTA to select product
306—E-commerce platform capture button to capture media
307—User's real world space with augmented elements
308—Digital 3D object augmented on world space
309—Gesture to control placement & appearance of digital 3D object

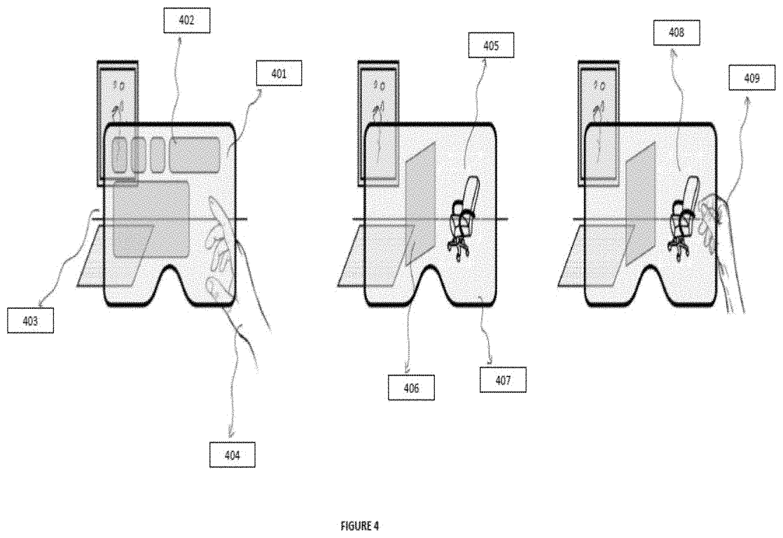

Referring to FIG. 4, an exemplary use case in accordance with exemplary embodiments of the present invention is shown. FIG. 4 illustrates possibilities of using via an AR glass, one or more gesture in an AR environment generated for an e-commerce platform based on the implementation of the features of the present invention. More specifically, the FIG. 4 depicts the following steps:
401—Wearable device field of view
402—E-commerce platform running on wearable device
403—User's real world space
404—Gesture being performed by user to select product in the e-commerce platform
405—Digital 3D object augmented on world space
406—Digital element detailing 3D object's specifications augmented on world space
407—User's real world space with augmented elements
408—Digital 3D object augmented on world space
409—Gesture to control placement & appearance of digital 3D object

Thus, the present invention provides a novel solution for providing an augmented reality environment for a digital platform. More particularly, the present invention provides a solution to invoke the functionality of augmenting products inside a digital platform to perform various gesture based actions. Also, the present invention provides a solution related to purchase of products through the specific use of Augmented Reality technology. A key advantage of the present invention is the inclusion of one or more gestures to help users build familiarity, access AR functionality easier, and view products before the purchase or completion of a transaction.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for providing an augmented reality environment for a digital platform, the method comprising:
receiving, at a transceiver unit [102] from an electronic device, a user input via the digital platform, wherein the user input comprises at least one camera invoking gesture;
enabling, by a processing unit [104], a camera functionality of a camera unit of the electronic device, based on the camera invoking gesture;
receiving, by the processing unit [104] from one or more sensors, a surrounding environment data based on the enabled camera functionality; and
generating, by the processing unit [104], the augmented reality environment associated with the digital platform, based on the surrounding environment data.

2. The method as claimed in claim 1, further comprising:
providing, by the processing unit [104], at least one recommendation in the generated augmented reality environment, based on a pre-trained dataset;
receiving, at the transceiver unit [102], a selection gesture for selecting the at least one recommendation in the generated augmented reality environment; and
automatically selecting in the generated augmented reality environment, by the processing unit [104], the at least one recommendation based on the selection gesture.

3. The method as claimed in claim 2 wherein providing, by the processing unit [104], the at least one recommendation in the generated augmented reality environment is further based on at least one of a user intent, a user preference, a user historical data and the surrounding environment data.

4. The method as claimed in claim 1, further comprising:
receiving, at the transceiver unit [102], a request for information associated with at least one object in the generated augmented reality environment;
providing in the generated augmented reality environment, by the processing unit [104], a first set of data based on the received request for information associated with the at least one object.

5. The method as claimed in claim 4, further comprising:
receiving, at the transceiver unit [102], at least one action gesture for performing one or more actions on the first set of data, in the generated augmented reality environment; and
automatically, performing in the generated augmented reality environment, by the processing unit [104], the one or more actions on the first set of data based on the at least one action gesture.

6. The method as claimed in claim 4, wherein providing in the generated augmented reality environment, by the processing unit [104], the first set of data further comprises:
generating, by the processing unit [104], a personalized first set of data based on at least one of the user preference, the user historical data and the surrounding environment data, wherein the personalized set of data is further generated by modifying at least one parameter associated with the first set of data; and
providing, by the processing unit [104] the personalized first set of data.

7. The method as claimed in claim 5, wherein automatically, performing in the generated augmented reality environment, by the processing unit [104], the one or more actions on the first set of data is further based on the one or more auto authentication options.

8. The method as claimed in claim 1, wherein the at least one camera invoking gesture is based on at least one of one or more tactile commands, one or more audio commands, one or more gaze focal point detection techniques, one or more logics and one or more muscle movements.

9. The method as claimed in claim 2, wherein the selection gesture is based on at least one of the one or more tactile commands, the one or more audio commands, the one or more gaze focal point detection techniques, the one or more logics and the one or more muscle movements.

10. The method as claimed in claim 5, wherein the at least one action gesture is based on at least one of the one or more tactile commands, the one or more audio commands, the one or more gaze focal point detection techniques, the one or more logics and the one or more muscle movements.

11. The method as claimed in claim 4, wherein the at least one object comprises at least one of one or more products, one or more persons and one or more buildings.

12. A system for providing an augmented reality environment for a digital platform, the system comprising:
a transceiver unit [102], configured to receive from an electronic device, a user input via the digital platform, wherein the user input comprises at least one camera invoking gesture;
a processing unit [104], configured to:
enable, a camera functionality of a camera unit of the electronic device, based on the camera invoking gesture,
receive, from one or more sensors, a surrounding environment data based on the enabled camera functionality, and
generate, the augmented reality environment associated with the digital platform, based on the surrounding environment data.

13. The system as claimed in claim 12, wherein the processing unit [104] is further configured to provide, at least one recommendation in the generated augmented reality environment, based on a pre-trained dataset, wherein:
the transceiver unit [102] is further configured to receive, a selection gesture for selecting the at least one recommendation in the generated augmented reality environment, and
the processing unit [104] is further configured to automatically select in the generated augmented reality environment, the at least one recommendation based on the selection gesture.

14. The system as claimed in claim 13 wherein the processing unit [104] is further configured to provide the at least one recommendation in the generated augmented reality environment based on at least one of a user intent, a user preference, a user historical data and the surrounding environment data.

15. The system as claimed in claim 12, wherein the transceiver unit [102] is further configured to receive a request for information associated with at least one object in the generated augmented reality environment, wherein
the processing unit [104] is further configured to provide in the generated augmented reality environment, a first set of data based on the received request for information associated with the at least one object.

16. The system as claimed in claim 15, wherein the transceiver unit [102] is further configured to receive at least one action gesture for performing one or more actions on the first set of data, in the generated augmented reality environment, wherein:
the processing unit [104] is further configured to automatically perform in the generated augmented reality environment, the one or more actions on the first set of data based on the at least one action gesture.

17. The system as claimed in claim 15, wherein the processing unit [104] is further configured to:
generate, a personalized first set of data based on at least one of the user preference, the user historical data and the surrounding environment data, wherein the personalized set of data is further generated by modifying at least one parameter associated with the first set of data; and
provide, the personalized first set of data.

18. The system as claimed in claim 16, wherein the processing unit [104] is further configured to automatically perform in the generated augmented reality environment, the one or more actions on the first set of data based on the one or more auto authentication options.

19. The system as claimed in claim 12, wherein the at least one camera invoking gesture is based on at least one of one or more tactile commands, one or more audio commands, one or more gaze focal point detection techniques, one or more logics and one or more muscle movements.

20. The system as claimed in claim 13, wherein the selection gesture is based on at least one of the one or more tactile commands, the one or more audio commands, the one or more gaze focal point detection techniques, the one or more logics and the one or more muscle movements.

21. The system as claimed in claim 16, wherein the at least one action gesture is based on at least one of the one or more tactile commands, the one or more audio commands, the one or more gaze focal point detection techniques, the one or more logics and the one or more muscle movements.

22. The system as claimed in claim 15, wherein the at least one object comprises at least one of one or more products, one or more persons and one or more buildings.
